(19) United States
(12) Patent Application Publication
(10) Pub. No.: US 2023/0049181 A1
(43) Pub. Date: Feb. 16, 2023

(54) Device for controlling external opening of an automobile vehicle door

(71) Applicant: AKWEL VIGO SPAIN SL, Vigo Pontevedra (ES)

(72) Inventors: Delmiro Javier COUTO MAQUIEIRA, Pontevedra (ES); José Oscar VAZQUEZ CARBALLO, Vigo (ES); Oscar PAMPIN AGRA, Vigo Pontevedra (ES); Julio GARCIA RODRIGUEZ, Pontevedra (ES)

(73) Assignee: AKWEL VIGO SPAIN SL, Vigo Pontevedra (ES)

(21) Appl. No.: 17/871,313

(22) Filed: Jul. 22, 2022

(30) Foreign Application Priority Data
Jul. 22, 2021 (FR) 2107932

(51) Int. Cl. E05B 81/90; E05B 81/04; E05B 79/20; E05B 79/06; E05B 85/16

(52) U.S. Cl. CPC E05B 81/90; E05B 81/04; E05B 79/20; E05B 79/06; E05B 85/16

(57) ABSTRACT

A bracket to be mounted in a cut-out in a panel of the door, a gripping handle hingedly mounted with respect to the bracket. The handle includes a body of generally elongate shape having an end portion for hinging to the bracket about a hinge axis substantially parallel to the plane of the panel of the door and substantially perpendicular to the longitudinal direction of the handle. The bracket has a body of casing defining a cavity open to the outside, which the handle partially closes off in a rest position leaving a concave access recess for gripping an internal face of the handle.

### TECHNICAL FIELD

The present invention relates to a device for controlling external opening of an automobile vehicle door. The invention relates more particularly but not exclusively to such a control device which combines an electric actuator and a mechanical actuator, suitable for triggering the opening of a lock of the automobile vehicle door.

As the external appearance of automobile vehicles has become one of the main factors of attractiveness and success, this invention relates to a device for controlling external opening of a side door of the vehicle, which is both very practical in use and has an external appearance that opens up new prospects for improving style of automobile vehicles, particularly the side style.

Generally, the control device comprises an operating plate (or gripping handle) which is hingedly mounted with respect to a body panel of the door, inside a casing. This casing is usually housed inside a cut-out provided to that end in the body panel.

A current trend is to allow opening of the door by means of an electric actuator, which is itself manually triggered, for example, by a slight pressure, a simple touch or a detection of a close presence of a user in a predefined zone of the control device, generally a non-visible internal face of the operating plate. Upon such manual actuation, an electrical control for unlocking the vehicle door is generated to the vehicle's main control unit.

For safety reasons, it is usually ensured that the door control device allows mechanical opening in the event of an electrical fault. Opening of the mechanical actuator is made with, for example, the application of a substantially higher actuating force to the operating plate, which then results in the mechanical release of the door by actuating a transmission assembly, for example a rod connected to the lock.

### PRIOR ART

Such a control device is known especially from prior art, and in particular from the publication of international application WO2021/009294A1.

Such a design of the opening control device allows it to operate particularly intuitively because the motorist who wishes to open the vehicle door proceeds, in the same pulling motion, firstly to an attempt to electrically unlock the lock mechanism associated with the plate by manually triggering the electric actuator located in an internal gripping zone of the plate, and then, only if the opening of the door fails, by exerting a higher intensity tensile force on the handle. The door is then opened without any change of motion by exerting an upward oriented tensile force on the plate, which causes pivoting of the plate and mechanical actuation of the lock.

However, this prior art control device has a number of drawbacks.

First of all, it turns out to be particularly complex to mount because it comprises a large number of pieces that need to be assembled together. In addition, gripping of the plate is also of low optimisation from an ergonomic point of view because it requires the user to twist his/her wrist when he/she mechanically actuates the lock of the door.

Faced with these drawbacks, the present invention aims at further improving external opening control devices of the type under consideration. In particular, one purpose of the invention is to provide an external opening control device that is more ergonomic and simpler to assemble, while offering new perspectives in the style of the vehicle.

### SUMMARY OF THE INVENTION

To this end, one object of the invention is a device for controlling external opening of an automobile vehicle door, comprising a bracket to be mounted in a cut-out in a panel of the door, a gripping handle hingedly mounted with respect to the bracket between at least one retracted rest position and a deployed open position for the mechanical actuation of a lock of the door, and wherein the bracket has a body of casing delimiting a cavity open to the outside, which the handle partially closes off in the rest position, leaving an access recess for gripping an internal face of the handle, characterised in that the handle comprises a body of generally elongate shape along a longitudinal direction having an end portion for hinging to the bracket about a hinge axis substantially parallel to the plane of the panel of the door and substantially perpendicular to the longitudinal direction of the handle.

By virtue of the invention, assembly of the device is simplified by virtue of hinging the handle to the body of the casing in an arrangement perpendicular to the longitudinal direction of the handle of the device. In particular, this facilitates the arrangement of the mechanism for actuating the lock while being more ergonomic when the handle is operated. This arrangement also provides a new style of automobile vehicle door, allowing the handle to be relatively unobtrusively integrated into its immediate environment without resorting to complex means.

In one preferred embodiment of the invention, the handle is provided with a leg for mechanically actuating the lock and extending transversely, configured to act on a transmission assembly connected to the lock.

In one preferred embodiment of the invention, the device comprises a manual control element disposed on the internal face of the handle by means of which an electrical control for the electrical actuation of the lock can be generated such that a user can proceed, in a single gripping motion of the handle, to the electrical actuation of the lock and, in case of failure, the mechanical actuation of the lock by applying a tensile stress to the handle towards the open position.

In one preferred embodiment of the invention, the device comprises a shell shaped to line the recess, the handle and the shell being configured to cooperate with each other such that the shell cannot be removed from the bracket after assembly of the handle to the bracket.

In one preferred embodiment of the invention, the cavity of the bracket is configured to impose, on the shell, an intermediate mounting and/or dismounting position passing through a final location of the handle in the cavity of the bracket.

In one preferred embodiment of the invention, the cavity and the shell are shaped to prevent the shell from being placed along a transverse direction of interlocking inside the cavity directly at a final destination position of the shell.

In one preferred embodiment of the invention, the bracket comprises a location for transversely receiving a dummy barrel piece provided with a front presentation face, the handle being configured in the bracket to cover the presentation face in the rest position.

In one preferred embodiment of the invention, the barrel piece comprises means for attaching to a side wall of the bracket.

In one preferred embodiment of the invention, the device comprises a mechanism for resisting the opening of the gripping handle from its rest position to its open position which has a hard point crossing separating at least a first trajectory part for opening the handle with high tensile stress from a second trajectory part with low tensile stress.

In one preferred embodiment of the invention, the opening resistance mechanism comprises a blocking lever movably mounted in the bracket from a configuration for blocking movement of the handle to a configuration for releasing movement of the handle, the resistance mechanism comprising means for resiliently returning the blocking lever to the blocking configuration.

In one preferred embodiment of the invention, the blocking lever comprises a cam profile and the handle comprises an actuation leg configured to act on a transmission assembly of the lock provided at an end with a follower finger cooperating along the cam profile upon application of a tensile stress to the handle.

In one preferred embodiment of the invention, the cam profile has a ramp provided with at least one inflection point defining the two trajectory parts.

In one preferred embodiment of the invention, the lever forms a reversing lever configured to pull a tensile cable of the lock, when moving to its release configuration.

In one preferred embodiment of the invention, the bracket comprises a housing for receiving and guiding the elastic means and the lever is slidably movably mounted along the longitudinal direction of the housing.

In one preferred embodiment of the invention, the bracket comprises a passageway extending from the outside to the lever into which a tool for mounting the handle can engage to temporarily move the lever against the means to allow release of movement of the handle to a mounting position.

In one preferred embodiment of the invention, the handle extends flush with the panel of the door and has an external surface which defines shape and/or appearance continuity with a surface of the panel of the door. For reasons of vehicle aerodynamics and aesthetics, the operating handle is preferably made flush with a body skin of the door panel. The door panel receiving the control device is then provided with a cavity open to the outside to allow the user to slide his/her hand behind the handle, in order to grip the inner gripping surface constituting the gripping area of the handle.

### BRIEF DESCRIPTION OF THE DRAWINGS

Further characteristics and advantages of the invention will become apparent in light of the following description, made with reference to the accompanying drawings in which:

FIG. 1 represents a perspective view of an external face of a vehicle door panel incorporating in the front an external opening control device according to the invention;

FIG. 2 represents a perspective view of an internal face of the panel of FIG. 1;

FIG. 3 represents a perspective view of the panel of FIG. 1 in an unassembled configuration;

FIG. 4 represents a perspective view of a rear face of the device of FIG. 1;

FIG. 5 represents a cross-sectional view of the device of FIG. 4 along a longitudinal section plane;

FIG. 6 represents an enlarged-scale perspective view of an opening resistance mechanism of the device of FIG. 1;

FIG. 7 represents another perspective view of the opening resistance mechanism of FIG. 6 and its immediate environment;

FIG. 8 represents a partially cutaway perspective view of the control device of FIG. 1 in which a manual switch element for electrically actuating a lock of the door is apparent;

FIG. 9 represents a perspective view of the handle bracket of the device of FIG. 1 and of the panel of the door in the assembled state;

FIG. 10 represents a perspective view of the handle bracket of the device of FIG. 1 and the panel of the door being assembled;

FIG. 11 represents an enlarged-scale detail perspective view of quick coupling means of a handle bracket of the device of FIG. 1 and the panel of the door in a mounted configuration;

FIG. 12 illustrates an enlarged-scale detail perspective view of quick coupling means of a handle bracket of the device of FIG. 1 and the panel of the door in a dismounted configuration;

FIG. 13 illustrates a step of assembling a lining shell of the device of FIG. 1 to the panel of the door;

FIG. 14 illustrates a step of assembling a handle of the device to the panel of the door;

FIG. 15 schematically illustrates a step of assembling the device of the invention;

FIG. 16 schematically illustrates a step of assembling the device of the invention;

FIG. 17 illustrates three steps of opening the handle, an extreme rest position (position A), an intermediate open position (position B) and a final open position (position C).

FIG. 18 represents a perspective view of the device of the invention of FIG. 1 for being installed on a “driver's side” door;

FIG. 19 represents the device of FIG. 1 during mounting of a lining shell according to two different assembly modes (A or B).

### DESCRIPTION OF THE EMBODIMENTS

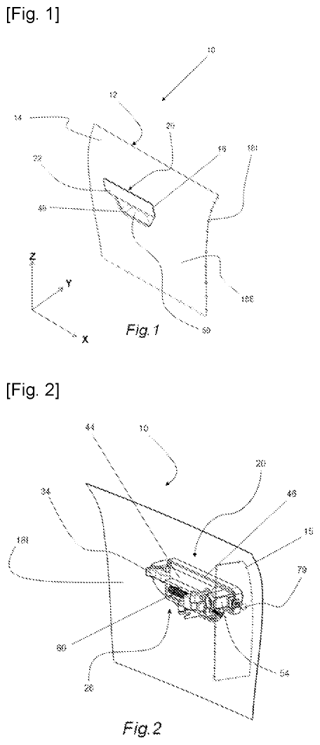

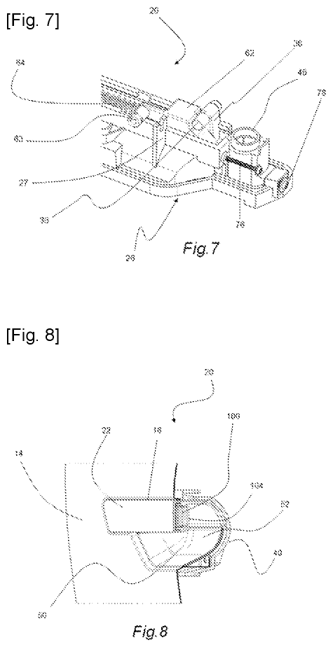

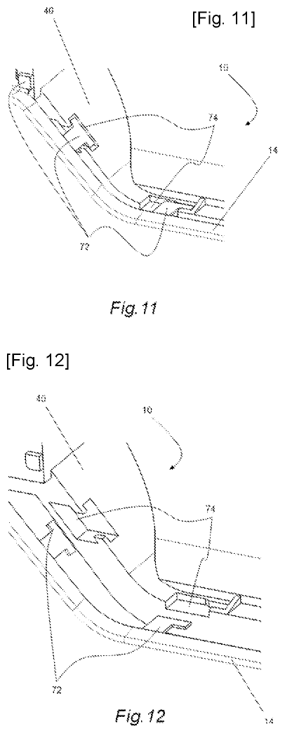

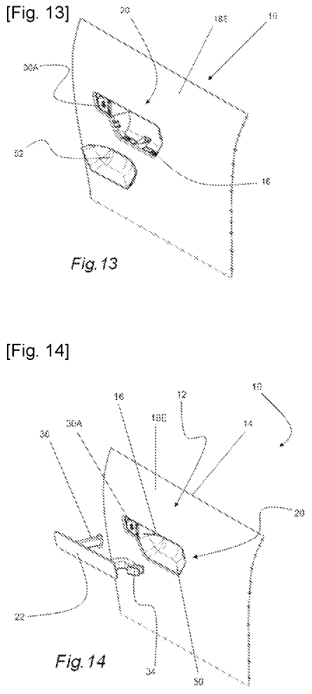

FIGS. 1 to 19 represent a device for controlling external opening of an automobile vehicle door according to the invention. In the remainder of the description, the device will be referred to by the general reference 20, the door by the general reference 12 and the automobile vehicle by the general reference 10.

An orthonormal reference frame is indicated in FIG. 1. It defines a first direction corresponding to a longitudinal axis X of the vehicle, oriented positively from the front to the rear of the vehicle, a second direction corresponding to a transverse axis Y of the vehicle and a third direction corresponding to a vertical axis Z of the vehicle.

In FIGS. 1 and 2, the control device 20 is to be mounted to an external body panel 14 of the door 12, which is for example a side door of the automobile vehicle 10. The panel 14 comprises a visible external face 18E and a hidden internal face 181.

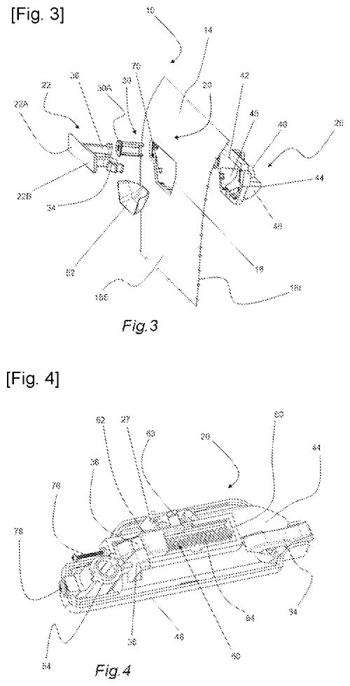

In general, as can be seen in FIG. 3, the device 20 comprises a handle bracket 26 to be mounted in a complementarily shaped cut-out 16 formed in the external panel 14 of the door 12 and a gripping handle 22 pivotably mounted to the bracket 26.

Conventionally, the automobile vehicle 10 also comprises a door lock (not shown) typically mounted to the door 12 of the vehicle 10 and configured to be mechanically and/or electrically actuated.

In this example, the handle 22 is intended for operation of the door 14 as well as for mechanical actuation of the lock of the automobile vehicle 10. Preferably, the lock is connected to the operating handle 22 via a mechanical connection (also referred to as a transmission assembly), which will be explained in detail later, and which enables the mechanical actuation of the opening.

Generally, the opening of a door of an automobile vehicle is made by means of a lock comprising a bolt (not represented) integral with the door capable of cooperating with a striker plate (not represented) integral with the body of the vehicle. In practice, the action of releasing the bolt is known as opening the lock, which allows the door to be unhooked. Conversely, the act of keeping the bolt in the striker plate, which prohibits the door from being unhooked, is known as closing the lock.

For example, the function of the lock is to hold the door 12 of the automobile vehicle 10 in the closed position. The lock also allows the door 12 to be unhooked by an action on the external opening control device 20 which is connected to the lock and actuatable by a user. The bolt is released from the striker plate by electrical or mechanical actuation of the external opening control 20.

The opening of the lock can be made electrically with an electromechanical actuator (not represented in the figures). In this case, the actuator (not represented) comprises, for example, an electric motor, which is electrically powered by the vehicle's main electrical system. This electric motor is sized to allow the lock and door to open under normal operating conditions.

The lock is also preferably connected to a central electronic unit (not represented in the figures) for controlling locking and unlocking of the various locks fitted to the automobile vehicle 10.

In the preferred embodiment of the invention, the device 20 further comprises a barrel piece 30 having a front presentation face 30A. In the example illustrated in FIG. 3, the barrel piece 30 has a generally cylindrical shape with one preferably relatively planar front presentation face.

In the event of an electrical failure, the lock can preferably be unlocked mechanically. To this end, in a “driver's” door configuration of the vehicle 10, conventionally, the barrel piece 30 of the device 20 is functional and is configured to allow insertion of a lock key through its presentation face 30A. As illustrated in FIG. 18, in this case, the device 20 comprises a cover-like lock guard 32 which is provided to be removably mounted (rotatably hinged or not) over the location of the barrel piece 30 and can be manually removed to provide access to the presentation face 30A to allow insertion of the lock key.

When the control device 20 is provided to be mounted in a so-called “passenger's” door configuration, as illustrated in FIG. 3, the barrel piece 30 is preferably a dummy part and is inoperative. Preferably, in this case, the handle 22 is configured to cover the location of the barrel piece 30 in its rest position.

Preferably, as illustrated in FIG. 3, the bracket 26 is formed by a body of casing 40 which is to be attached to the inner side 181 of the panel 14 and the gripping handle 22 is to be arranged on the outer side 18E of the panel 14, while being fitted to the bracket-forming body of casing 40.

In this example embodiment, the gripping handle 22 is in the form of a generally elongate body extending in the longitudinal direction X.

As is clear from FIG. 1, the handle 22 is in the form of an elongate bar, along the longitudinal direction X. The side of the handle 22 that includes the hinge axis will be referred to as the rear side 22B and the opposite side will be referred to as the front side 22A. This rear to front orientation corresponds substantially to a right to left orientation in FIG. 1.

In accordance with the invention, as is visible in FIG. 3, the handle 22 is hingedly mounted to the bracket 26 by the rear end side 22B about a hinge axis extending in the vertical direction Z relative to the body of casing 40. The hinge axis will be referred to as vertical, that is, substantially parallel to the plane of the external panel 14 and perpendicular to the longitudinal direction X of the gripping handle 22.

The gripping handle 22 is hingedly mounted about the geometric hinge axis with respect to the bracket 26 between at least one extreme retracted rest position and an extreme deployed open position resulting in the mechanical actuation of the opening of the lock of the door 12 resulting in the unhooking of the door 12.

In order to enable the handle 22 to be hinged, in the illustrated example, its rear side 22B includes a forked end 34 provided to be rotatably mounted about a pivot shaft of the bracket 26 (not visible in the figures).

Furthermore, in the illustrated example, on the front side 22A, the handle 22 is mechanically connected to the lock mechanism. This allows, by virtue of the operation of the handle 22, the mechanical actuation of the opening of the lock and the unhooking of the door 14.

To this end, preferably, the handle 22 comprises, on its front side 22A, a transversely extending actuation leg 36 configured to act on a transmission assembly coupled to the lock mechanism which allows the mechanical opening of the lock of the door 12. The transmission assembly comprises, for example, a tensile cable and a reversing lever 62 which will be described in more detail below.

As is clear from FIG. 2 or 3, the body of casing 40 frontally has a front face 42 open to the outside of the door 12 in a generally frame-like shape and a rear wall 44 which is arranged to extend to the inner side of the panel 14 of the door 12. The body of casing 40 further comprises in this example a peripheral wall 46 which together with the rear wall 44 delimits a cavity 48 for receiving the handle 22, open to the outside of the door 12.

Preferably, as is visible in FIG. 2, the cavity 48 of the body of casing 40 is arranged in the panel 14 of the door 12 to extend recessed from the external surface of the panel 14 and thereby receive the gripping handle 22 substantially flush with the external surface of the panel 14 (or vehicle body skin). Preferably, the handle 22 has an external surface which defines surface continuity with a surface of the panel 14 of the door 12 and possibly also appearance continuity.

As illustrated in the figures, the handle 22 is arranged in the body of casing 40 to partially close off the inner cavity 48 of the body of casing 40 in the rest position such that in the illustrated example, a lower longitudinal edge of the handle 22 vertically delimits a concave clearance 50 downward, in the form of, for example, a cup or half-bowl allowing insertion of a user's hand behind the handle 22.

In the retracted position of the handle 22, the cavity 48 open to the outside is partially closed off by the handle 22 so as to make an internal face of the handle 22 accessible for gripping through the clearance 50. Indeed, when the user's hand slides into the clearance 50 of the body of casing 40, the internal face of the user's phalanges faces the inner face of the handle 22.

Alternatively, of course, the handle 22 may be arranged to close off a lower portion of the inner cavity 48 such that an upper longitudinal edge of the handle 22 vertically delimits the concave clearance upward in this case. It is also contemplatable that the handle 22 may be arranged to close off a middle portion of the inner cavity 48 such that the handle 22 vertically delimits concave clearances both upward and downward.

Preferably, in the preferred embodiment of the invention, the device 20 further comprises a lining shell 52 configured to fit snugly the clearance 50 of the open cavity 48 of the casing 40 not closed off by the handle 22 in its rest position. In this example, the shell 52 forms a finishing trim to line the part of the recess 48 of the body of casing 40 not covered by the handle 22 in its rest position.

For example, as represented in FIG. 10, the casing 40 functionally comprises at least two parts: a first upper part for receiving the handle 22 in the rest position and a second lower access part for gripping the handle 22 in its rest position. This second portion comprises the concave recess 48 open to the outside which forms the access clearance 50 to the internal face of the handle 22 in its retracted rest position.

In the illustrated example, the body of casing 40 comprises, in the longitudinal direction at one end of its first part, a location in which a bore 54 is formed, shaped to transversely house the barrel piece 30 such that the barrel 30 frontally has its presentation face 30A.

Furthermore, preferably in the so-called “passenger's” door configuration, the front end part 22A of the handle 22 is shaped to cover the presentation face 30A in the rest position of the handle 22. In the preferred embodiment of the invention, the front end part 22A of the handle 22 forms a front longitudinal extension of the handle 22 beyond a position of the actuation leg 36 of the handle 22.

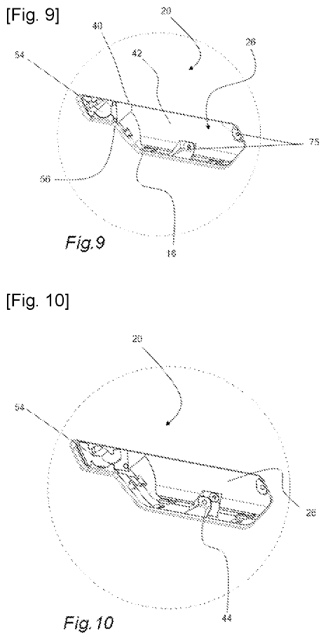

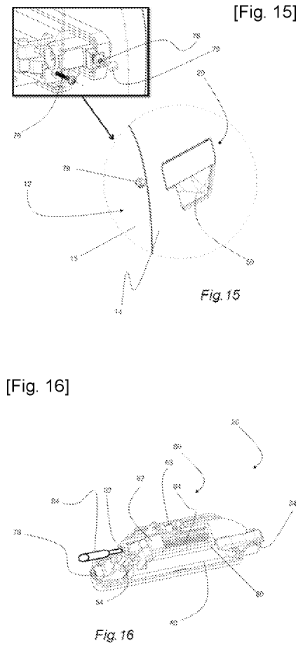

In the preferred embodiment of the invention, the visual delimitation of the first and second parts of the body of casing 40 is marked by a vertical shoulder-forming step 56 visible in FIG. 9. In the illustrated example, the body of casing 40 has a generally oblong shaped contour and is provided with a lobe-shaped bump in which the location for the cylindrical bore 54 for receiving the barrel piece 30 is located. In the example illustrated in FIG. 15, the barrel piece 30 comprises means for attachment 78 to a side wall of the bracket 26.

Preferably, as shown in FIG. 8, the device 10 also comprises a manual control element 100 disposed on an internal face for gripping the handle 22 by means of which an electrical control for electrically opening the lock of the door 12 can be generated.

The manual control element 100 may for example comprise, by way of non-limiting example, a gestural and/or touch detector configured to detect at least one control instruction related to a result of the gestural and/or touch detection in a control region preferably located on the internal face of the handle 22.

The detector comprises, for example, a sensor using pressure-sensitive resistor technology (also known as an FSR sensor for Force Sensing Resistor), for example using pressure-sensitive resistive inks, optical technology or capacitive technology. Such technologies are well known to the person skilled in the art and will not be described in greater detail hereafter.

By virtue of this manual control, which can be activated by a simple touch, very slight pressure or detection of the user's presence, the user can proceed, in a single gripping motion of the handle 22, to the electric unlocking of the door lock and, only in the event of failure, mechanical unlocking of the door lock by applying a tensile stress to the handle towards the open position.

In normal operation of the device 20, the handle 22 is provided to occupy its retracted rest position for the most part and to be operated only occasionally.

Thus, preferably, in order to avoid untimely movement of the handle 22 upon electrical actuation of the device 20, the device 20 further comprises a mechanism 60 for resisting the opening of the handle 22 from its rest position to its open position. The mechanism 60 comprises, for example, a hard point crossing that separates at least a first trajectory part for opening of the handle 22 with high tensile stress from a second trajectory part with low tensile stress.

In the example, the opening resistance mechanism 60 comprises a blocking lever 62 movably mounted in the body of casing 40 from a configuration for blocking the handle 22 in a retracted position to a configuration for releasing the handle 22 to its deployed position. The resistance mechanism 60 preferably comprises means 62 for elastically returning the lever to the blocking configuration.

Preferably, the blocking lever 62 comprises a cam profile 66 and the actuation leg 36 of the handle 22 is provided at an end with a follower finger 38 cooperating along the cam profile 66 (FIG. 6) upon application of a tensile stress to the handle 22 towards its open position (the movement of the follower finger 38 and the lever 62 is represented as a dashed line).

Preferably, the cam profile 66 has a ramp provided with at least one inflection point P separating the first trajectory part with relatively higher tensile stress and a second trajectory part with relatively lower tensile stress.

Preferably, the blocking lever 62 comprises means for mechanical connection to a mechanical transmission element of the lock, such as a cable. In this case, the blocking lever 62 forms part of the mechanical transmission assembly and is configured to pull the tensile cable of the lock, when moving to its release configuration. In the example described, movement of the handle 22 to its deployed open position results in moving the lever 62 and thereby causing pulling of the cable causing unhooking of the lock.

Preferably, the bracket 26 also comprises a housing 80 for receiving and guiding the elastic return means 64 and the blocking lever 62, which is slidably movably mounted along the longitudinal direction of the housing 80. The housing 80 is in this example in the form of a generally rectangular frame extending lengthwise along the longitudinal direction of the bracket 26 on the rear wall 44. In the preferred embodiment of the invention, the actuation leg 36 of the handle 22 extends transversely inside the bracket 26 by passing through the rear wall 44 of the casing 40 so that the end of the actuation leg 36 cooperates with the resistance mechanism 60 of the handle 22 located at the rear of the casing 40 (FIG. 2).

In particular, in FIG. 16 the follower finger 38 is seen to extend inside the housing 80 along the vertical direction Z and is positioned in contact with the ramp portion 66 of the lever 62. The lever 62 is in this example guided for movement along the main sliding direction of the housing 80.

Preferably, as illustrated in FIG. 16, the bracket 26 comprises a passageway 82 extending from the outside to the blocking lever 62 into which a temporary mounting tool 84 may engage which may be, for example, a screw 76 (FIG. 15) or a specifically shaped mounting part such as that represented in FIG. 16. When the tool 84 is inserted into the passageway 82, for example formed by a through hole 82 in a wall of the frame of the housing 80, it can temporarily move the blocking lever 62 against the elastic return means 64 to allow the handle 22 to be installed in its final mounting destination position inside the casing 40.

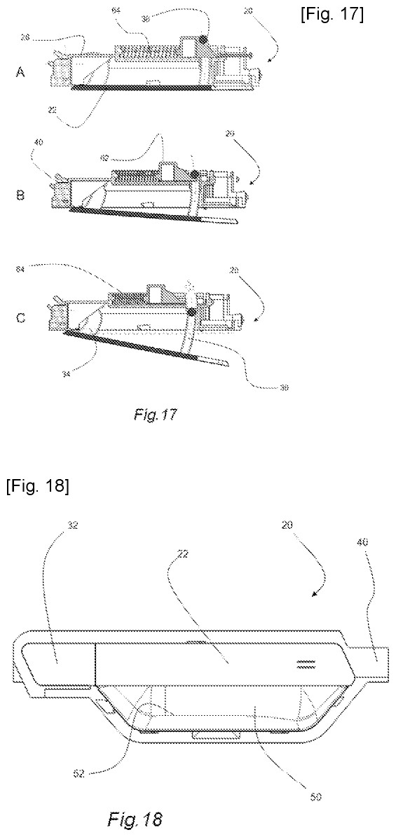

For example, advantageously, when the mounting tool 84 is a mounting screw 76 as illustrated in FIG. 15, the device 20 may be delivered pre-assembled with the mounting screw 76 in the screwed-in state that is, engaging the blocking lever 62 in the configuration for releasing the handle 22 allowing the handle 22 to be readily installed in its rest mounting position (FIG. 17, position A). Once the handle 22 is installed on the bracket 26, the mounting screw 76 can be unscrewed to release the blocking lever 62 and allow it to spring back into the configuration for blocking the handle 22 by virtue of the elastic means 64.

The elastic return member 64 comprises a compression-operating spring in this example. In the illustrated example, the lever 62 comprises a main stud-shaped body provided with a bearing face with the spring 64. The lever 62 further comprises a cable pulling arm which is formed as an extension of the main body. For example, the arm comprises a swivel-shaped cable retaining end 63 and the bracket 26 also comprises a cable guide member 27. The lever 62 preferably comprises a longitudinally extending protrusion opposite the bearing face of the spring delimiting the ramp profile. In the illustrated example, the bearing face of the lever 62 also comprises a pin 68 for centring the spring 64.

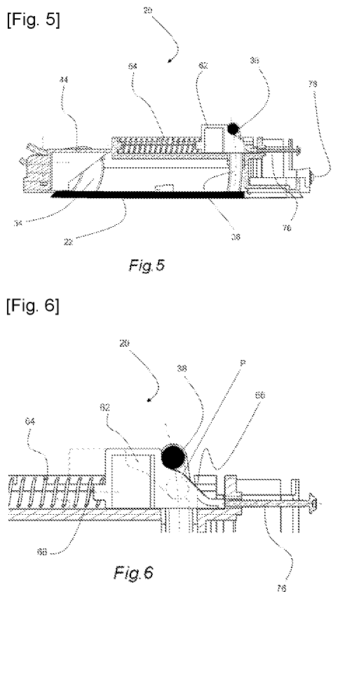

The main operating aspects of the opening resistance mechanism 60 will now be described with reference to FIGS. 5 to 7 and 16 and 17. As is apparent in FIGS. 5 and 6 and FIG. 17 (position A), in the rest position, the lever 62 is held in a blocking configuration by the deployed spring 64, preventing the handle 22 from being opened inadvertently. In the event of a high tensile stress exerted on the handle 22 (FIG. 17, position B), the application of the follower finger 38 along the trajectory of the cam profile of the lever 62 causes the lever 62 to be pushed back into the housing 80, against the action of the return spring 64, which at the end of the trajectory allows the complete release of the handle 22 to its final open position (FIG. 17, position C).

The device 20 according to the invention is also distinguished from prior art by a simplicity of design allowing simple and robust assembly without the need for multiple pieces.

Indeed, in the example illustrated in FIG. 3, the body of casing 40 forming the bracket 26 is fitted by quick coupling means 70 to the panel 14 of the door 12. As is visible in FIGS. 3, 5 and 6, the panel 14 of the door 12 has a plurality of snap-fit or interlocking projections 72 on the periphery of its cut-out 16, and the body of casing 40 comprises a plurality of complementary cavities 74 arranged on the peripheral edge of the front face of the casing 40.

In this example, the projections 72 and complementary cavities 74 form the quick coupling means 70. However, other quick coupling means can be contemplated without departing from the scope of the invention. These quick coupling means of the two pieces (the body of the casing 40 and the panel 14) advantageously allow the two pieces to be positioned relative to each other before being attached to each other by conventional attachment means 75. This allows for easy, quick and accurate positioning of the bracket 26 when mounted to the door panel 14.

In the example illustrated in FIG. 8, the body of casing 40 is seen to be secured to the panel 14 by conventional attachment means 75 such as screws and attachment holes.

Furthermore, preferably, the door 12 has a hole 79 in the side configured to allow access for attaching the screws 76 and 78 (FIGS. 2 and 15). This hole 79 is, for example, accessible through a side wall 15 of the door 12 when opening the door 12.

The trim shell 52 and the bracket 26 are preferably shaped to be interlocked into each other as illustrated in FIG. 14. The shell 52 is shaped to line the recess 50, the handle 22 and the shell 52 being configured to cooperate with each other such that the shell 52 cannot be removed from the bracket 26 after assembly or installation of the handle 22 on the bracket 26 in its final mounting destination position.

Preferably, the cavity 48 of the bracket 26 is configured to impose, on the shell 52, an intermediate mounting and/or dismounting position passing through a final location of the handle 22 in the cavity 48 of the bracket 26. In the illustrated example, the shell 52 achieves an intermediate mounting position passing through the first portion of the body of casing 40 for receiving the handle 22. Consequently, once the handle 22 is positioned in the cavity 48, the shell 52 cannot be removed without passing through the location for receiving the handle 22 which is then rendered impassable by the handle 22.

Preferably, the cavity 48 and the shell 52 are shaped to prevent the shell 52 from being placed along a transverse direction of interlocking inside the cavity 48 directly into a final destination position of the shell 52.

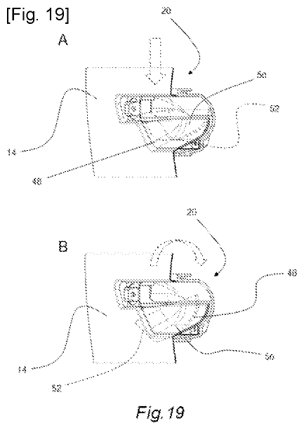

For example, with reference to FIG. 19, the intermediate mounting position (represented in dotted lines) is a vertically upper position with respect to the final destination position of the shell 52 in the bracket 26 (mode A) or is an inclined position with respect to the final destination position of the shell 52 (mode B) or a combination of these two intermediate positions.

Such an external opening control device 20 reduces the number of pieces to be supplied, handled and mounted.

Of course, the invention is not limited to the previously described embodiments. Other embodiments within the scope of the person skilled in the art may also be contemplated without departing from the scope of the invention defined by the following claims.

1. A device for controlling external opening of a door of an automobile vehicle, comprising a bracket to be mounted in a cut-out in a panel of the door, a gripping handle hingedly mounted with respect to the bracket between at least one retracted rest position and a deployed open position for the mechanical actuation of a lock of the door and wherein the bracket has a body of casing defining a cavity open to the outside, which the handle partially closes off in the rest position leaving a concave access recess for gripping an internal face of the handle, wherein the handle comprises a body of generally elongate shape along a longitudinal direction having an end part for hinging to the bracket about a hinge axis substantially parallel to the plane of the panel of the door and substantially perpendicular to the longitudinal direction of the handle.

2. The device according to claim 1, wherein the handle is provided with a leg for mechanically actuating the lock and extending transversely, configured to act on a transmission assembly connected to the lock.

3. The device according to claim 1, comprising a manual control element disposed on the internal face of the handle by means of which an electrical control for the electrical actuation of the lock can be generated such that a user can proceed, in a single gripping motion of the handle, to the electrical actuation of the lock and, in the event of failure, the mechanical actuation of the lock by applying a tensile stress to the handle towards the open position.

4. The device according to claim 1, comprising a shell shaped to line the recess, the handle and the shell being configured to cooperate with each other such that the shell cannot be removed from the bracket after assembly of the handle to the bracket.

5. The device according to claim 4, wherein the cavity of the bracket is configured to impose, on the shell, an intermediate mounting and/or dismounting position passing through a final location of the handle in the cavity of the bracket.

6. The device according to claim 4, wherein the cavity and the shell are shaped to prevent the shell from being placed along a transverse direction of interlocking inside the cavity directly into a final destination position of the shell.

7. The device according to claim 1, wherein the bracket comprises a location for transversely receiving a dummy barrel piece provided with a front presentation face, the handle being configured in the bracket to cover the presentation face in the rest position.

8. The device according to claim 7, wherein the barrel piece comprises means for attachment to a side wall of the bracket.

9. The device according to claim 1, comprising a mechanism for resisting the opening of the gripping handle from its rest position to its open position which has a hard point crossing separating at least a first trajectory part for opening the handle with high tensile stress from a second trajectory part with low tensile stress.

10. The device according to claim 9, wherein the opening resistance mechanism comprises a blocking lever movably mounted in the bracket from a configuration for blocking movement of the handle to a configuration for releasing movement of the handle, the resistance mechanism comprising means for elastically returning the blocking lever to the blocking configuration.

11. The device according to claim 10, wherein the blocking lever comprises a cam profile and the handle comprises an actuation leg configured to act on a transmission assembly of the lock provided at an end with a follower finger cooperating along the cam profile upon application of a tensile stress to the handle.

12. The device according to claim 11, wherein the cam profile has a ramp provided with at least one inflection point defining the two trajectory parts.

13. The device according to claim 10, wherein the lever forms a reversing lever configured to pull a tensile cable of the lock, when moving to its release configuration.

14. The device according to claim 10, wherein the bracket comprises a housing for receiving and guiding the elastic means and the lever is slidably movably mounted along the longitudinal direction of the housing.

15. The device according to claim 10, wherein the bracket comprises a passageway extending from the outside to the lever into which a tool for mounting the handle can engage to temporarily move the lever against the means to allow release of movement of the handle to a mounting position.

16. The device according to claim 1, wherein the handle extends flush with the panel of the door and has an external surface which defines shape and/or appearance continuity with a surface of the panel of the door.
